(19) United States
(12) Patent Application Publication
(10) Pub. No.: US 2008/0095344 A1
(43) Pub. Date: Apr. 24, 2008

(54) Presence Agent for a Telephone

(75) Inventor: Jack Jachner, Lexington, MA (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: Alcatel Lucent, Paris (FR)

(21) Appl. No.: 11/574,900

(22) PCT Filed: Sep. 17, 2004
(86) PCT No.: PCT/US04/30500

§ 371 Date: Mar. 8, 2007

(51) Int. Cl. H04M 15/00

(52) U.S. Cl. 379/133

(57) ABSTRACT

A presence agent (100) for a telephone line (102) operable to provide telephony presence information to a presence client. A line monitor (104) is included for collecting line status information by monitoring a telephone line associated with the telephone. A presence entity module (108) is coupled to the line monitor for processing the line status information into presence data operable to be transmitted over an IP-based network (110).

### BACKGROUND OF THE INVENTION

1. Technical Field of the Invention

The present invention generally relates to presence-aware communication networks. More particularly, and not by way of any limitation, the present invention is directed to a presence agent for a telephone whereby presence information pertaining to the telephone is provided to one or more presence clients.

2. Description of Related Art

With today's widespread use of the Internet as a major communication medium, data communication devices are now being designed so that they are capable of communicating over packet-switched networks. For instance, telephones, pagers, personal digital assistant devices, cell phones, handheld computers, and even fax machines can now be accessed and controlled from the Internet. Communication over a packet-switched network using communication devices that traditionally communicate over a circuit-switched telecommunications network is generally known as network telephony, or IP telephony when an IP network is involved.

Various types of user communication devices (e.g., a cell phone, laptop or handheld PC, desktop PC, and the like) can identify themselves to the network using a suitable identifier (e.g., username@company.com). “Presence” refers to, for example, the availability, proximity, activity level or operating state of a user or device on a network. The ability for users to monitor each other's presence is a feature offered in connection with many applications that support network telephony. For example, instant messaging applications such as MSN®, Yahoo®, et cetera have an “available buddy” feature, in which a user of the application can determine whether select users are available for engaging in communication. The data retrieved and returned to the buddy list, e.g. “John OFFLINE” or “Susan ACTIVE”, is known as “presence information,” and is generally maintained by a presence server in the data network, often a dedicated server. Typically, the presence server supports network telephony protocols such as the Session Initiation Protocol (SIP). Users can register their communication devices with the presence server in order to have their presence maintained and to allow various programs on the network to facilitate network telephony services. A first device user wishing to detect the presence of a second device user does so by “subscribing” with the presence server, such as via a SIP SUBSCRIBE message. The presence server intermediates between the first device user (also known as the watcher or subscriber) and the second device user to facilitate the communication of the second device user's presence information to the first device user.

Additional details concerning presence and presence data modeling are set forth in the Internet Engineering Task Force (IETF) Request for Comment (RFC) 2778 entitled “A model for Presence and Instant Messaging,” dated February 2002; RFC 2779 entitled “Instant Messaging/Presence Protocol Requirements,” dated February 2002; and Internet-Draft identified as <<draft-schulzrinne-simple-rpids-01.ps>> and entitled “RPIDS—Rich Presence Information Data Format for Presence Based on the Session Initiation Protocol (SIP),” dated Feb. 18, 2003, which are incorporated herein by reference.

Although presence applications have been implemented in a variety of settings such as those exemplified hereinabove, one area that remains deficient in terms of presence is the well known Plain Old Telephone Service (POTS). Currently, telephony experience involving POTS phone sets consists of dialing a destination number or called number and experiencing either a busy signal, ring with no answer, or ring with forwarding to voice mail, or ring and pickup followed by conversation, et cetera. If presence information about the called party were available to the calling party in real time or substantially real time prior to the call, the caller could avoid making an unsuccessful call if the presence indication of the destination was busy. An additional benefit would be that the occurrence of voice mail tags would be reduced.

### SUMMARY OF THE INVENTION

In one aspect, the present invention is directed to a presence agent for a telephone operable to provide telephony presence information to a presence client. A line monitor is included for collecting line status information by monitoring a telephone line associated with the telephone. A presence entity module is coupled to the line monitor for processing the line status information into presence data operable to be transmitted over an IP-based network.

In another aspect, the present invention is directed to a system for providing telephony presence information to a presence client, wherein an analog telephone is connected to a Public Switched Telephone Network (PSTN) via a telephone line. A presence agent unit is operably disposed for disseminating presence information relating to the analog phone over a presence-aware network to which the presence client is coupled, wherein the presence information is based on line activity of the telephone line associated with the analog telephone.

In yet another aspect, the present invention is directed to a system for providing telephony presence information to a presence client, wherein an analog telephone is connected via a telephone line for effectuating Voice-over-IP (VoIP) communications over an IP network. A VoIP broadband modem disposed at the analog phone's premises is operable for interfacing with the IP network. A presence agent unit is operably disposed for disseminating presence information relating to the analog phone over a presence-aware network to which the presence client is coupled, wherein the presence information is based on line activity of the telephone line associated with the analog telephone.

In a further aspect, the present invention is directed to a presence agent for a POTS telephone. The presence agent comprises a structure for collecting line status information by monitoring a telephone line associated with the telephone, and a structure for processing the line status information into presence data operable to be transmitted over an IP-based network.

In a still further aspect, the present invention is directed to a method for providing telephony presence information to a presence client. The method comprises collecting line status information by monitoring a telephone line associated with an analog telephone of a presence service customer, and processing the line status information into presence data for transmitting over an IP-based network.

### BRIEF DESCRIPTION OF THE DRAWINGS

The accompanying drawings are incorporated into and form a part of the specification to illustrate one or more presently preferred exemplary embodiments of the present invention. Various advantages and features of the invention will be understood from the following Detailed Description taken in connection with the appended claims and with reference to the attached drawing figures in which:

FIG. 1A depicts a functional block diagram of a presence agent for a telephone in accordance with an embodiment of the present invention;

FIG. 1B depicts an embodiment of a line monitor operable as part of the presence agent shown in FIG. 1;

FIG. 1C depicts additional circuitry provided as part of an embodiment of line monitor circuitry for collecting line status information for purposes of the present patent application;

FIG. 2 depicts an exemplary embodiment of a presence information model format for transmission in a presence service involving the presence data collected for a telephone;

FIG. 3 depicts a service application embodiment wherein a telephony presence agent is deployed as a standalone module;

FIG. 4 depicts another service application embodiment wherein a telephony presence agent is deployed as a standalone module having wireless data link capability;

FIG. 5 depicts another service application embodiment wherein a telephony presence agent is deployed as a module integrated within an analog telephone;

FIG. 6 depicts another service application embodiment wherein a telephony presence agent is deployed as a module integrated within an analog telephone, the module having wireless data link capability;

FIG. 7 depicts another service application embodiment wherein a telephony presence agent is deployed as a module integrated within an broadband modem;

FIG. 8 depicts another service application embodiment wherein a telephony presence agent is deployed as a module integrated within a VoIP-capable broadband modem;

FIG. 9 depicts another service application embodiment wherein a telephony presence agent is deployed as a module associated with a PSTN node; and

FIG. 10 depicts a flow chart of the operations involved in effectuating a telephony presence service in accordance with an embodiment of the present invention.

### DETAILED DESCRIPTION OF THE DRAWINGS

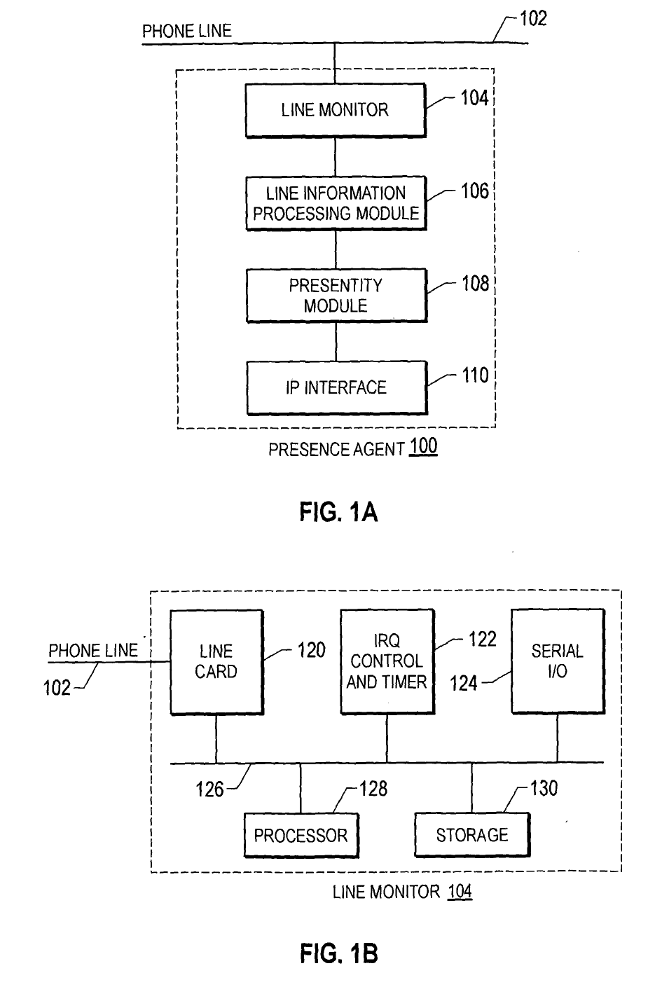

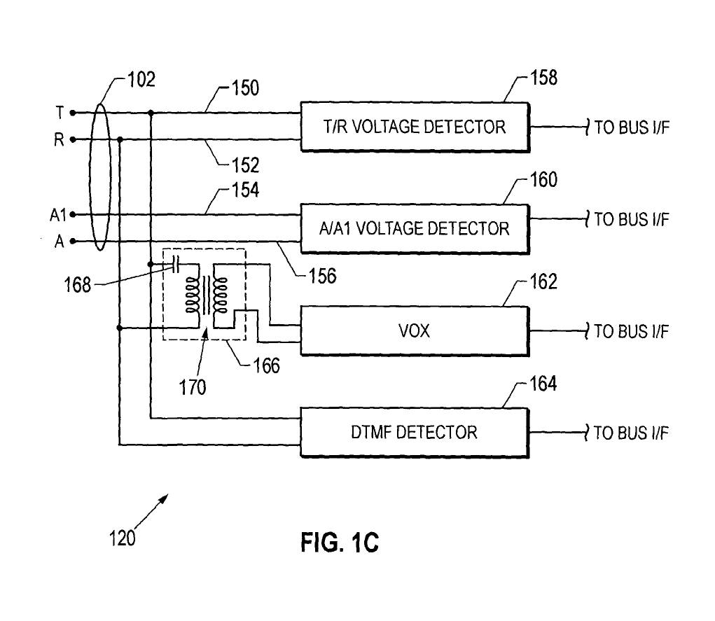

Embodiments of the invention will now be described with reference to various examples of how the invention can best be made and used. Like reference numerals are used throughout the description and several views of the drawings to indicate like or corresponding parts, wherein the various elements are not necessarily drawn to scale. Referring now to the drawings, and more particularly to FIG. 1, depicted therein a functional block diagram of a presence agent 100 for a telephone in accordance with an embodiment of the present invention. By way of exemplary implementation, it is envisaged that the present agent 100 is operable for disseminating presence data relating to the status of an analog Plain Old Telephone Service (POTS) telephone (not shown in this FIG.) that is serviced by an analog telephone line 102. A line monitor 104 is operable for collecting line status information by monitoring the telephone line 102 as will be described in additional detail hereinbelow. A line information processing module 106 is operable as a presence user agent in conjunction with a presentity module 108 for manipulating the line status information into appropriate presence data to be transmitted over an Internet Protocol (IP)-based network via an IP interface 110. For example, the presence data relating to the serviced telephone (which may be referred to as telephony presence information) can include conditions, features, and capabilities such as whether the line is idle, busy, call forwarded, do-not-disturb, enabled with call waiting, enabled with caller ID, etc. and other presence information elements based on DTMF detection and Caller ID detection, e.g., number called (outgoing number that was dialed from DTMF), number calling (incoming number from Caller ID), DTMF signaling (which might be used to activate features in the PSTN or in the far end terminal or service), and the like.

Those skilled in the art will recognize upon reference hereto that the various functional blocks of the presence agent 100 may be embodied in hardware, software, and/or firmware, or in any combination thereof. Additionally, the presence information may be formatted in conformity with any known or heretofore unknown IP-based protocols adaptable for presence applications, e.g., H.323 protocol, Session Initiation Protocol (SIP), and the like. Additional presence-specific protocols operable with the presence agent 100 may also include Extensible Messaging and Presence Protocol (XMPP)-based applications such as Jabber.

For purposes of the present patent application, a telephony presence service servicing the telephony presence agent 100 is provided with the capability to transact the following operations: (i) transmit messages from one agent to other agents and/or exchange messages with other agents (i.e., other users or presence clients); (ii) transmit presence information from one agent to other agents and/or exchange presence information with other agents; (iii) manage items in a contact list (buddy list or roster list); and (iv) block communications to or from one or several specific presence agents.

FIG. 1B depicts a block diagrammatic embodiment of the line monitor 104 operable as part of the presence agent 100 described above. In an exemplary implementation, one or more line cards, e.g., line card 120, are operable to service one or more POTS analog phone lines, e.g., line 102, with respect to collecting line status information on each line being monitored. Along with the line cards, an interrupt (IRQ) control and timer card 122 and a serial input/output (I/O) card 124 are coupled to one or more processors 128 and memory storage units 130 via a bus 126. It should be apparent to those skilled in the art that any known processor/memory/bus architecture may be used in conjunction with the line card functionality for purposes of the present invention.

Referring now to FIG. 1C, additional circuitry of the line card 120 is illustrated therein for collecting line status information in accordance with the teachings of the present invention. In this embodiment, four inputs corresponding to a tip-and-ring (T/R) pair as well as a common ground and control lead (A1/A) pair of the telephone line 102 are provided to a number of detector or monitor circuits that are in turn coupled to a bus interface (not shown in this FIG.). By way of exemplary implementation, a T/R voltage detector 158 is operable to receive tip 150 and ring 152 as inputs for generating a signal indicative of the voltage between the T/R pair of the line 102. For instance, if the voltage on the T/R leads exceeds or falls below 40 VDC, appropriate logic signals may be provided to the bus interface. Likewise, another voltage detector 160 is coupled between common ground (A1) terminal 154 and control lead (A) terminal 156 for generating logic signals indicative of the voltage levels therebetween. A voice detect (VOX) circuit 162 is coupled to the T/R pair of the line 102 by means of an interface circuit 166 comprising a capacitor 168 and a transformer 170. The VOX circuit 162 is operable to provide a digital signal to the bus interface that is indicative of the presence or absence of voice signals on the tip and ring leads of the telephone line 102. Any voice detect circuitry, conventional or otherwise, may be employed as the VOX circuit 162. For instance, the voice detect circuitry may include a standard syllabic detector which places an output signal in a first digital logic state approximately 5 seconds after the detection of voice on the T/R leads, and places the output signal in a second digital logic state approximately 5 seconds after the last detection of voice on the T/R leads. This 5-second delay may be variable and is selected to prevent the VOX output signal from changing state during normal pauses in conversation, but to indicate significant lapses therein, as for example when a receiver is in off-hook condition and the subscriber is otherwise occupied (for instance, the subscriber is busy retrieving information from a book).

Additionally, a Dual-Tone Multi-Frequency (DTMF) detector 164 may be provided as part of the line monitor circuitry 120 of a telephony presence agent according to one embodiment of the present invention. The DTMF detector 164 is coupled to the T/R pair of the line for monitoring the DTMF signaling, e.g., conventional Touch-Tone signals effectuated on the telephone line that are communicated to the serving Central Office (CO) or End Office (EO) to invoke known DTMF features. Also, the functionality of a line sampler may be provided as part of the line monitor circuitry wherein the line is sampled to detect dial-stutter tones for determining if an unanswered call to the monitored phone resulted in a message waiting indication for PSTN-based voice mail systems.

It should be understood, however, the exemplary line monitor circuitry provided hereinabove may be suitable for a 2-wire telephone line as well, with appropriate modifications. Accordingly, based on the foregoing discussion, it should be apparent that the line monitoring functionality of the present invention's telephony presence agent provides the capability to gauge the overall signaling environment of an analog telephone line, thereby determine the status, conditions and features/capabilities of the associated telephone. As alluded to before, such line status information can include a plurality of line states such as idle (no activity on telephone line), ring (ringing signal present on telephone line), inter-ring (condition of being in-between rings), off-hook (telephone is off hook), serviced (line off hook and not on hold)-which in turn may includes the states of voice or no-voice based on the presence or absence of voice signals, on-hold (off hook line placed on hold), et cetera. The line status information as well as DTMF signaling conditions are manipulated by the presence agent into appropriate presence data that may be transmitted over the IP-based presence-aware network.

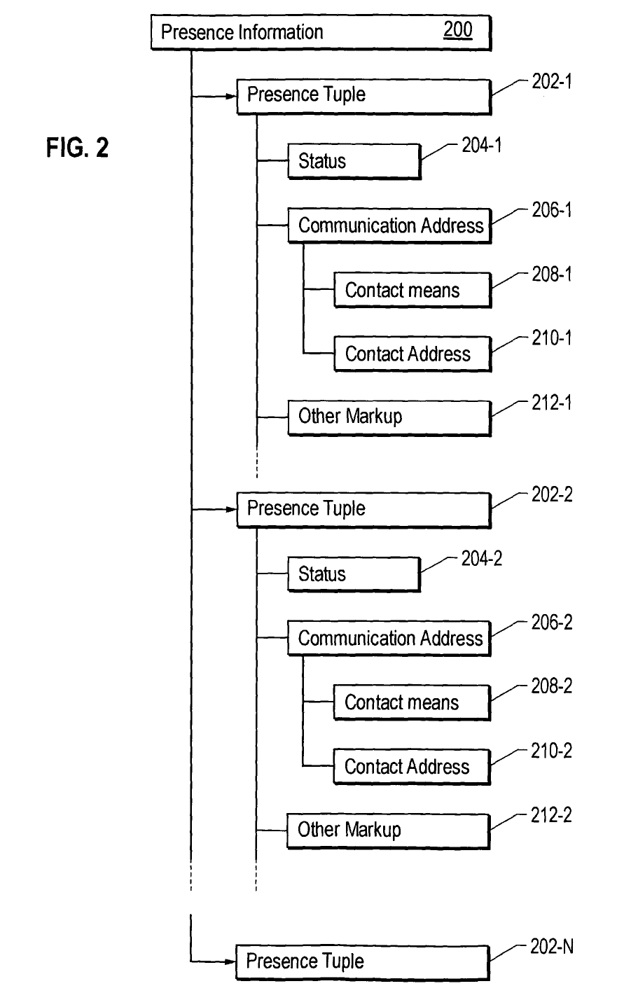

FIG. 2 depicts an exemplary embodiment of a presence information model format 200 for transmission in a telephony presence service involving a presence agent such as the telephony presence agent 100 set forth above. As illustrated, the presence information model format 200 comprises an arbitrary number (N) of elements, referred to as “presence tuples” 202-1 through 202-N. Each such element includes a status marker and other markups operable to convey information (such as, e.g., idle; online; offline; busy; do not disturb, etc., as well as transaction capability attributes or features) for indicating a presence condition or an attribute of the monitored telephone. Additionally, an optional communication address, and one or more optional other presence markups may also be included in a presence tuple. A communication address includes a communication contact means and a contact address. By way of example, reference numerals 202-1 and 202-2 refer to two presence tuples of the presence information model 200, wherein status markers 204-1, 204-2, communication addresses 206-1, 206-2, and other markups 212-1, 212-2 are illustrative. Communication address 206-1 is further defined by a contact means 208-1 and a contact address 210-1. Likewise, communication address 206-1 is also defined in terms of a contact means 208-2 and associated contact address 210-2. It should be appreciated that although only one communication address per presence tuple is shown, there may be additional communication addresses for any presence tuple, each having its own contact and contact address information, based on the particular presence service application. For instance, in addition to an instant messaging address, a presence tuple may include a communication address that is defined for conventional wireless or wireline telephony, with the corresponding contact address being a cell phone number or a POTS telephone number.

By provisioning different status markers and related markups in the presence tuples, a telephony presence service may be designed appropriately for different types of telephony presence data based on signal monitoring. In terms of deployment, the presence agent is disposed in the analog loop of the monitored telephone set, wherein a number of implementations are possible, e.g., in the customer's premises of the telephone, at the border with the PSTN, or in a PSTN node (such as the local CO/EO). Additionally, since the presence agent requires an interface with the IP network (which can be a local area network, a wide area network, an enterprise intranet, a public packet-switched network, i.e., the Internet, et cetera), the presence agent may also be provided as a module or node that is integrated with a suitable broadband modem. These various service application embodiments will now be described immediately hereinbelow.

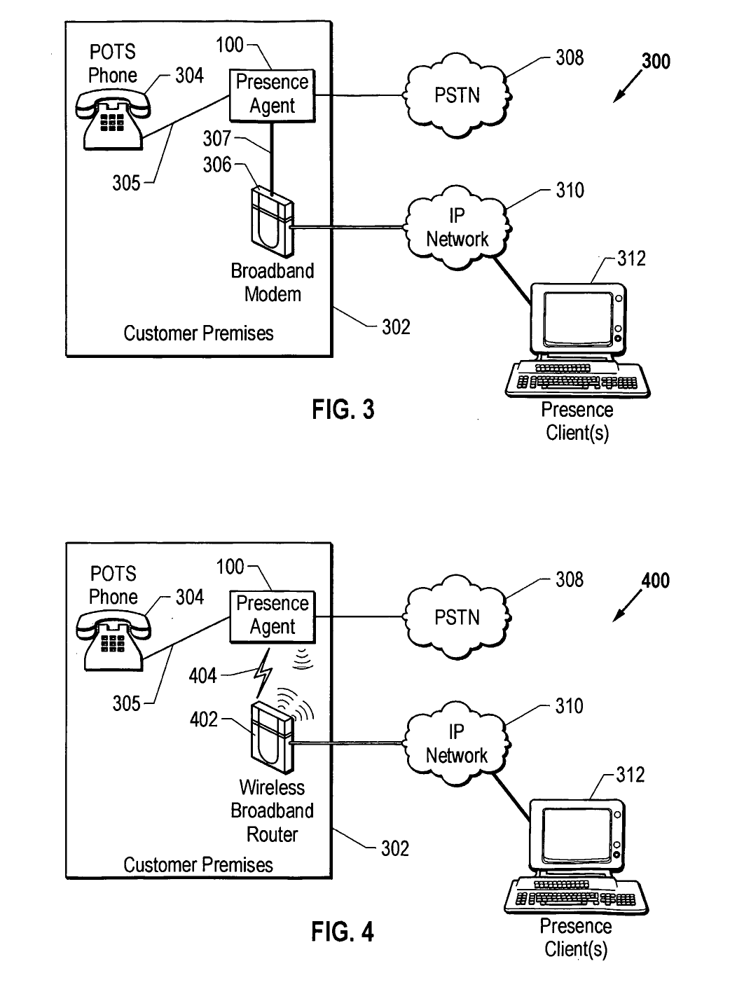

FIG. 3 depicts a service application embodiment 300 wherein the telephony presence agent (TPA) 100 of the present invention is deployed as a standalone module at a customer's premises 302. A conventional analog telephone 304 located at premises 302 is coupled to the PSTN 308 via a wireline phone connection 305 that is monitored by the presence agent 100 as set forth above. A broadband modem 306 such as, e.g., a Digital Subscriber Line (DSL) modem, a cable modem or a Fiber To The Unit (FTTU) modem, located at premises 302 provides connectivity to an IP network 310 that is operable as a presence-aware network including one or more presence service watchers, i.e., presence clients 312. A wired connection 307 is deployed at customer's premises for interfacing the presence agent 100 with the broadband modem 306. Depending on the type of presence service application, presence client 312 may operate as a fetcher that simply requests the current value of some presence information relating to the telephone 304, which request may be mediated via a presence server disposed in the IP network 310 for serving the presence agent 100. Further, as a poller, a fetcher client may periodically obtain presence information via the network 310 on some sort of a regular basis. Alternatively, presence client 312 may operate as a subscriber that requests notification from the presence server serving the presence agent 100 of changes (including future changes) in specific presence information relating to the telephone 304.

FIG. 4 depicts another service application embodiment 400 wherein the telephony presence agent 100 is deployed as a standalone module having wireless data link capability. As before, TPA 100 is located at customer's premises 302 for monitoring the wireline phone connection 305 associated with telephone 304 located thereat. A wireless-capable broadband router 402 (e.g., wireless fidelity or WiFi, Bluetooth, et cetera) is disposed at premises 302 for interfacing with the presence-aware IP network 310. A wireless data link connection 404 interfaces TPA 100 with the wireless broadband router 402 for facilitating the transport of presence information relating to the POTS phone 304 to one or more presence clients 312.

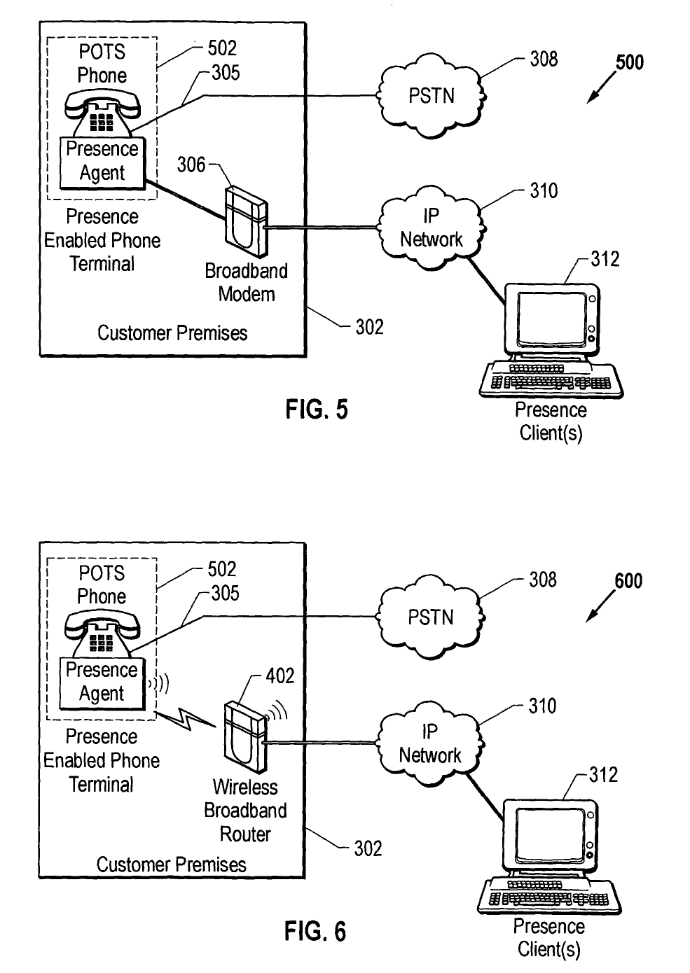

FIG. 5 depicts another service application embodiment 500 wherein a telephony presence agent is deployed as a module integrated within an analog telephone. A presence-enabled phone (PEP) terminal 502 deployed at customer's premises 302 is therefore coupled to the PSTN 308 via conventional wireline connection 305 as well as to the IP network 310 via broadband modem 306. A similar service application embodiment 600 is depicted in FIG. 6 wherein the telephony presence agent module of the PEP terminal 502 is provided with wireless data link capability for interfacing with the Wireless broadband modem 402 disposed at customer's premises 302.

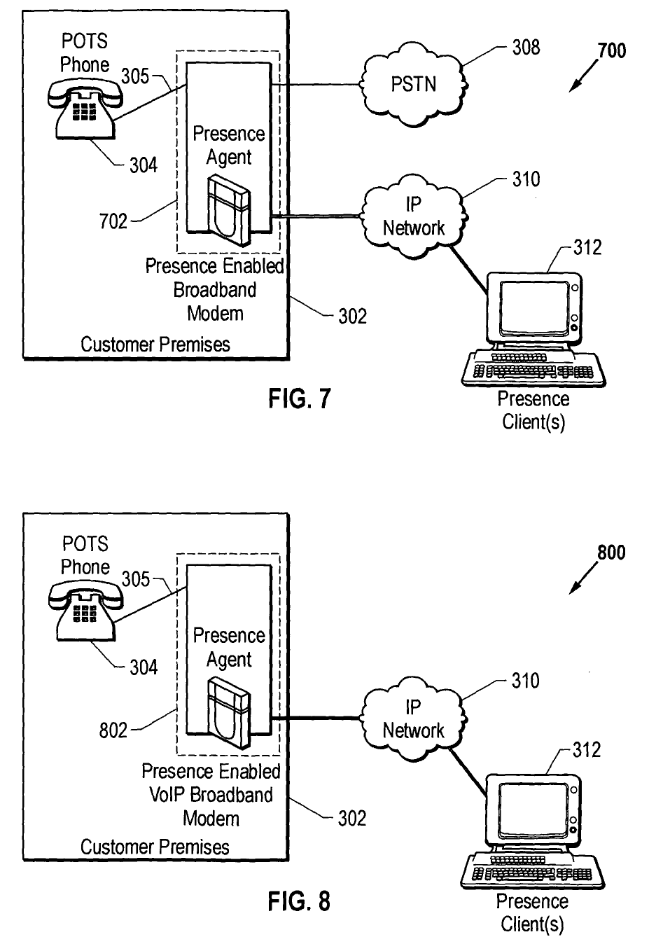

As an additional variation, FIG. 7 depicts a service application embodiment 700 wherein a telephony presence agent is deployed as a module integrated with a presence-enabled broadband (PEB) modem 702 that is located at customer's premises 302. The presence-aware broadband modem 702 is therefore interfaced not only with the IP network 310 but also with the wireline phone connection 305 associated with the POTS phone 304 for monitoring the line status information. FIG. 8 depicts another service application embodiment 800 wherein the POTS phone 304 is deployed in IP telephony rather than PSTN-based telephony. Similar to the embodiment depicted in FIG. 7, the telephony presence agent is deployed as a module integrated with a presence-enabled VoIP broadband modem 802 that is located at customer's premises 302 for interfacing with the IP network 310. The presence-aware VoIP broadband modem 802 is also coupled to the analog wireline connection 305 associated with the POTS phone 304 for monitoring the line status information as well as effectuating network telephony.

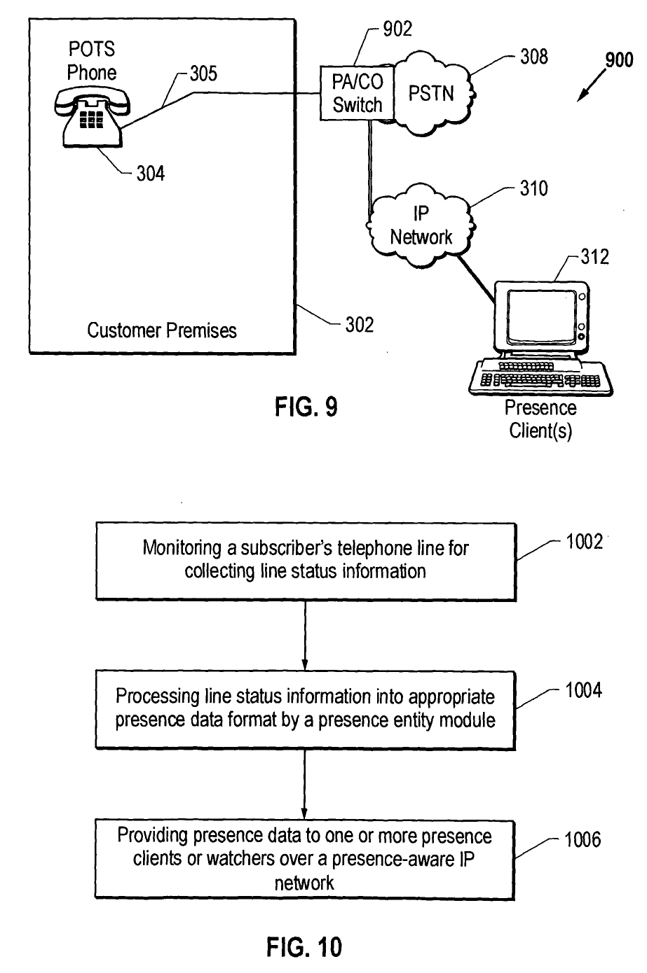

In a still further variation, the TPA functionality of the present invention may be associated with a PSTN node as exemplified by the embodiment 900 depicted in FIG. 9. For instance, in one service application implementation, the TPA may be deployed as a standalone module co-located at an EO/CO switch 902 serving the POTS phone 304. In another implementation, the TPA may be integrated within the equipment of switch 902. In either case, the TPA functionality may be expanded to cover more than a single telephone line by providing appropriate amount of line monitor and processor circuitry. Also, the PSTN-based TPA is provided with the capability to access the IP network 310 directly for transporting presence information relative to one or more POTS phones.

FIG. 10 depicts a flow chart of the operations involved in effectuating a telephony presence service in accordance with an embodiment of the present invention. At least one subscriber's analog phone line is monitored for collecting line status information (block 1002). In accordance with the description set forth above, the line status information includes a plurality of line states, tones (e.g., dial tone, ringing tone, dial-stutter tone, busy tone, etc.), DTMF signals, as well as information relating to available capabilities/features of the telephone set whose line is being monitored. It should be apparent that the telephone line may be monitored substantially intermittently, periodically, or based upon detection of a change in one or more components of the status information. The line status information is thereafter manipulated or processed into appropriate presence data by a presence entity module (block 1004), which is provided to one or more presence clients (i.e., watchers) over a presence-aware IP network as part of a telephony presence service application (block 1006). By way of example, a telephony presence service application may be provisioned to comprise a data model developed in well-known Markup languages such as Extended Markup Language (XML), Xs Unified Markup Language (UML), General Markup Language (GML), Agent Markup Language (AML), et cetera.

Based on the foregoing Detailed Description, it should be appreciated that the present invention advantageously provides a presence agent for supporting telephony presence applications that are envisaged to enrich the telephony experience of today in a fundamental way. By disseminating advance indication of a destination party's availability prior to the initiation of communication, numerous value propositions may be enabled such as, for instance, efficient calling when the destination party is available, polite calling that respect a do-not-disturb indication, prioritized calling that overrides a do-not-disturb indication in cases of an emergency, et cetera. Additionally, such value propositions make sound commercial sense based on current levels of penetration of analog phones in both domestic as well as foreign telecom markets.

Although the invention has been described with reference to certain exemplary embodiments, it is to be understood that the forms of the invention shown and described are to be treated as exemplary embodiments only. Accordingly, various changes, substitutions and modifications can be realized without departing from the spirit and scope of the invention as defined by the appended claims.

1. A presence agent for a telephone, comprising:
a line monitor for collecting line status information by monitoring a telephone line associated with said telephone; and
a presence entity module coupled to said line monitor for processing said line status information into presence data operable to be transmitted over an Internet Protocol (IP)-based network.

2. The presence agent for a telephone as recited in claim 1, wherein said telephone line comprises an analog telephone line.

3. The presence agent for a telephone as recited in claim 1, wherein said IP-based network comprises a local area network operable with a protocol selected from the group consisting of H.323 protocol, Session Initiation Protocol (SIP) and Extensible Messaging and Presence Protocol (XMPP).

4. The presence agent for a telephone as recited in claim 1, wherein said IP-based network comprises a wide area network operable with a protocol selected from the group consisting of H.323 protocol, Session Initiation Protocol (SIP) and Extensible Messaging and Presence Protocol (XMPP).

5. The presence agent for a telephone as recited in claim 1, wherein said IP-based network comprises an enterprise intranet network operable with a protocol selected from the group consisting of H.323 protocol, Session Initiation Protocol (SIP) and Extensible Messaging and Presence Protocol (XMPP).

6. The presence agent for a telephone as recited in claim 1, wherein said IP-based network comprises a public packet-switched network operable with a protocol selected from the group consisting of H.323 protocol, Session Initiation Protocol (SIP) and Extensible Messaging and Presence Protocol (XMPP).

7. The presence agent for a telephone as recited in claim 1, wherein said line monitor includes a voltage detector operable to detect voltage levels on a tip-and-ring (T/R) pair of said telephone line.

8. The presence agent for a telephone as recited in claim 1, wherein said line monitor includes a voltage detector operable to detect voltage levels on a common ground (A1) and control lead (A) pair of said telephone line.

9. The presence agent for a telephone as recited in claim 1, wherein said line monitor includes a voice detection circuit.

10. The presence agent for a telephone as recited in claim 1, wherein said line monitor includes a detector for detecting Dual Tone Multi-Frequency (DTMF) signaling on said telephone line.

11. The presence agent for a telephone as recited in claim 1, wherein said line status information includes a plurality of line states selected from the group consisting of: ring, off-hook, on-hook, serviced, and on-hold.

12. The presence agent for a telephone as recited in claim 1, wherein said line status information includes a plurality of tones selected from the group consisting of a dial tone, ringing tone, dial-stutter tone, and a busy tone.

13. The presence agent for a telephone as recited in claim 1, wherein said line status information includes DTMF signaling on said telephone line.

14. The presence agent for a telephone as recited in claim 1, wherein said line status information includes feature capability information relating to said telephone.

15. The presence agent for a telephone as recited in claim 1, wherein said line status information is formatted as at least one presence tuple by said presence entity module, said at least one presence tuple including one or more telephony presence information elements selected from the group consisting of: idle, busy, call forwarded, do-not-disturb, enabled with call waiting, enabled with caller ID, and other presence information elements based on DTMF signaling and detection and Caller ID detection.

16. A system for providing telephony presence information to a presence client, comprising:
an analog telephone connected to a Public Switched Telephone Network (PSTN) via a telephone line; and
a presence agent unit operably disposed for disseminating presence information relating to said analog phone over a presence-aware network to which said presence client is coupled, wherein said presence information is based on line status activity of said telephone line associated with said analog telephone.

17. The system for providing telephony presence information to a presence client as recited in claim 16, wherein said presence-aware network comprises an IP-based local area network operable with a protocol selected from the group consisting of H.323 protocol, Session Initiation Protocol (SIP) and Extensible Messaging and Presence Protocol (XMPP).

18. The system for providing telephony presence information to a presence client as recited in claim 16, wherein said presence-aware network comprises an IP-based wide area network operable with a protocol selected from the group consisting of H.323 protocol, Session Initiation Protocol (SIP) and Extensible Messaging and Presence Protocol (XMPP).

19. The system for providing telephony presence information to a presence client as recited in claim 16, wherein said presence-aware network comprises an IP-based enterprise intranet network operable with a protocol selected from the group consisting of H.323 protocol, Session Initiation Protocol (SIP) and Extensible Messaging and Presence Protocol (XMPP).

20. The system for providing telephony presence information to a presence client as recited in claim 16, wherein said presence-aware network comprises an IP-based public packet-switched network operable with a protocol selected from the group consisting of H.323 protocol, Session Initiation Protocol (SIP) and Extensible Messaging and Presence Protocol (XMPP).

21. The system for providing telephony presence information to a presence client as recited in claim 16, wherein said line status activity of said telephone line is monitored by detecting voltage levels on a tip-and-ring (T/R) pair of said telephone line.

22. The system for providing telephony presence information to a presence client as recited in claim 16, wherein said line status activity of said telephone line is monitored by detecting voltage levels on a common ground (A1) and control lead (A) pair of said telephone line.

23. The system for providing telephony presence information to a presence client as recited in claim 16, wherein said line status activity of said telephone line is monitored by detecting Dual Tone Multi-Frequency (DTMF) signaling on said telephone line.

24. The system for providing telephony presence information to a presence client as recited in claim 16, wherein said line status activity of said telephone line is monitored by detecting a plurality of tones selected from the group consisting of a dial tone, ringing tone, dial-stutter tone, a busy tone.

25. The system for providing telephony presence information to a presence client as recited in claim 16, wherein said line status activity of said telephone line is monitored by detecting a plurality of line states selected from the group consisting of: ring, off-hook, on-hook, serviced, and on-hold.

26. The system for providing telephony presence information to a presence client as recited in claim 16, wherein said presence information is formatted as at least one presence tuple by said presence agent unit based on said line status activity of said telephone line, said at least one presence tuple including one or more telephony presence information elements selected from the group consisting of: idle, busy, call forwarded, do-not-disturb, enabled with call waiting, enabled with caller ID, and other presence information elements based on DTMF signaling and detection and Caller ID detection.

27. The system for providing telephony presence information to a presence client as recited in claim 16, wherein said presence agent unit is provided as a standalone device located at said analog telephone's premises, said standalone device having a communication path to a broadband modem disposed thereat for interfacing with said presence-aware network.

28. The system for providing telephony presence information to a presence client as recited in claim 16, wherein said presence agent unit is provided as a standalone device located at said analog telephone's premises, said standalone device having a wireless communication path to a wireless broadband router disposed thereat for interfacing with said presence-aware network.

29. The system for providing telephony presence information to a presence client as recited in claim 16, wherein said presence agent unit is integrated with said analog telephone into a presence-enabled phone (PEP) terminal, said PEP terminal having a communication path to a broadband modem disposed at customer premises for interfacing with said presence-aware network.

30. The system for providing telephony presence information to a presence client as recited in claim 16, wherein said presence agent unit is integrated with said analog telephone into a presence-enabled phone (PEP) terminal, said PEP terminal having a wireless communication path to a wireless broadband router disposed at customer premises for interfacing with said presence-aware network.

31. The system for providing telephony presence information to a presence client as recited in claim 16, wherein said presence agent unit is integrated with a broadband modem into a presence-enabled broadband (PEB) modem disposed at customer premises for interfacing with said presence-aware network.

32. The system for providing telephony presence information to a presence client as recited in claim 16, wherein said presence agent unit is integrated with a Central Office (CO) switch disposed in said PSTN for serving said analog telephone, said presence agent unit having an interface to said presence-aware network.

33. A system for providing telephony presence information to a presence client, comprising:
an analog telephone connected via a telephone line for effectuating Voice-over-P (VoIP) communications over an Internet Protocol (IP) network;
a VoIP broadband modem disposed at said analog phone's premises for interfacing with said IP network; and
a presence agent unit operably disposed for disseminating presence information relating to said analog phone over said IP network to which said presence client is coupled, wherein said presence information is based on line status activity of said telephone line associated with said analog telephone.

34. The system for providing telephony presence information to a presence client as recited in claim 33, wherein said IP network comprises a local area network operable with a protocol selected from the group consisting of H.323 protocol, Session Initiation Protocol (SIP) and Extensible Messaging and Presence Protocol (XMPP).

35. The system for providing telephony presence information to a presence client as recited in claim 33, wherein said IP network comprises a wide area network operable with a protocol selected from the group consisting of H.323 protocol, Session Initiation Protocol (SIP) and Extensible Messaging and Presence Protocol (XMPP).

36. The system for providing telephony presence information to a presence client as recited in claim 33, wherein said IP network comprises an enterprise intranet network operable with a protocol selected from the group consisting of H.323 protocol, Session Initiation Protocol (SIP) and Extensible Messaging and Presence Protocol (XMPP).

37. The system for providing telephony presence information to a presence client as recited in claim 33, wherein said IP network comprises a public packet-switched network operable with a protocol selected from the group consisting of H.323 protocol, Session Initiation Protocol (SIP) and Extensible Messaging and Presence Protocol (XMPP).

38. The system for providing telephony presence information to a presence client as recited in claim 33, wherein said line status activity of said telephone line is monitored by detecting voltage levels on a tip-and-ring (T/R) pair of said telephone line.

39. The system for providing telephony presence information to a presence client as recited in claim 33, wherein said line status activity of said telephone line is monitored by detecting voltage levels on a common ground (A1) and control lead (A) pair of said telephone line.

40. The system for providing telephony presence information to a presence client as recited in claim 33, wherein said line status activity of said telephone line is monitored by detecting Dual Tone Multi-Frequency (DTMF) signaling on said telephone line.

41. The system for providing telephony presence information to a presence client as recited in claim 33, wherein said line status activity of said telephone line is monitored by detecting a plurality of tones selected from the group consisting of a dial tone, ringing tone, dial-stutter tone, a busy tone.

42. The system for providing telephony presence information to a presence client as recited in claim 33, wherein said line status activity of said telephone line is monitored by detecting a plurality offline states selected from the group consisting of: ring, off-hook, on-hook, serviced, and on-hold.

43. The system for providing telephony presence information to a presence client as recited in claim 33, wherein said presence information is formatted as at least one presence tuple by said presence agent unit based on said line status activity of said telephone line, said at least one presence tuple including one or more telephony presence information elements selected from the group consisting of: idle, busy, call forwarded, do-not-disturb, enabled with call waiting, enabled with caller ID, and other presence information elements based on DTMF signaling and detection and Caller ID detection.

44. The system for providing telephony presence information to a presence client as recited in claim 33, wherein said presence agent unit is integrated with said VoIP broadband modem into a presence-enabled broadband (PEB) modem co-located with said analog telephone.

45. A presence agent for a telephone, comprising:
means for collecting line status information by monitoring a telephone line associated with said telephone; and
means for processing said line status information into presence data operable to be transmitted over an Internet Protocol (IP)-based network.

46. The presence agent for a telephone as recited in claim 45, wherein said telephone line comprises an analog telephone line.

47. The presence agent for a telephone as recited in claim 45, wherein said IP-based network comprises a local area network operable with a protocol selected from the group consisting of H.323 protocol, Session Initiation Protocol (SIP) and Extensible Messaging and Presence Protocol (XMPP).

48. The presence agent for a telephone as recited in claim 45, wherein said IP-based network comprises a wide area network operable with a protocol selected from the group consisting of H.323 protocol, Session Initiation Protocol (SIP) and Extensible Messaging and Presence Protocol (XMPP).

49. The presence agent for a telephone as recited in claim 45, wherein said IP-based network comprises an enterprise intranet network operable with a protocol selected from the group consisting of H.323 protocol, Session Initiation Protocol (SIP) and Extensible Messaging and Presence Protocol (XMPP).

50. The presence agent for a telephone as recited in claim 45, wherein said IP-based network comprises a public packet-switched network operable with a protocol selected from the group consisting of H.323 protocol, Session Initiation Protocol (SIP) and Extensible Messaging and Presence Protocol (XMPP).

51. The presence agent for a telephone as recited in claim 45, wherein said means for collecting line status information includes means operable to detect voltage levels on a tip-and-ring (T/R) pair of said telephone line.

52. The presence agent for a telephone as recited in claim 45, wherein means for collecting line status information includes means operable to voltage levels on a common ground (A1) and control lead (A) pair of said telephone line.

53. The presence agent for a telephone as recited in claim 45, wherein means for collecting line status information includes means operable to detect voice signals over said telephone line.

54. The presence agent for a telephone as recited in claim 45, wherein means for collecting line status information includes means operable to detect Dual Tone Multi-Frequency (DTMF) signaling over said telephone line.

55. The presence agent for a telephone as recited in claim 45, wherein said line status information includes a plurality of line states selected from the group consisting of: ring, off-hook, on-hook, serviced, and on-hold.

56. The presence agent for a telephone as recited in claim 45, wherein said line status information includes a plurality of tones selected from the group consisting of a dial tone, ringing tone, dial-stutter tone, a busy tone.

57. The presence agent for a telephone as recited in claim 45, wherein said line status information includes DTMF signaling on said telephone line.

58. The presence agent for a telephone as recited in claim 45, wherein said line status information includes feature capability information relating to said telephone.

59. The presence agent for a telephone as recited in claim 45, wherein said line status information is formatted as at least one presence tuple by said means for processing said line status information, said at least one presence tuple including one or more telephony presence information elements selected from the group consisting of: idle, busy, call forwarded, do-not-disturb, enabled with call waiting, enabled with caller ID, and other presence information elements based on DTMF signaling and detection and Caller ID detection.

60. The presence agent for a telephone as recited in claim 45, wherein said line status information is collected periodically.

61. The presence agent for a telephone as recited in claim 45, wherein said line status information is collected substantially continuously.

62. The presence agent for a telephone as recited in claim 45, wherein said line status information is collected intermittently.

63. The presence agent for a telephone as recited in claim 45, wherein said line status information is collected upon a change in said line status information.

64. The presence agent for a telephone as recited in claim 45, wherein said line status information is collected upon a request by a presence client disposed in said IP-based network.

65. A method for providing telephony presence information to a presence client, comprising:
collecting line status information by monitoring a telephone line associated with an analog telephone of a presence service customer; and
processing said line status information into presence data for transmitting over an Internet Protocol (IP)-based network.

66. The method for providing telephony presence information to a presence client as recited in claim 65, wherein said IP-based network comprises a local area network operable with a protocol selected from the group consisting of H.323 protocol, Session Initiation Protocol (SIP) and Extensible Messaging and Presence Protocol (XMPP).

67. The method for providing telephony presence information to a presence client as recited in claim 65, wherein said IP-based network comprises a wide area network operable with a protocol selected from the group consisting of H.323 protocol, Session Initiation Protocol (SIP) and Extensible Messaging and Presence Protocol (XMPP).

68. The method for providing telephony presence information to a presence client as recited in claim 65, wherein said IP-based network comprises a public packet-switched network operable with a protocol selected from the group consisting of H.323 protocol, Session Initiation Protocol (SIP) and Extensible Messaging and Presence Protocol (XMPP).

69. The method for providing telephony presence information to a presence client as recited in claim 65, wherein said IP-based network comprises an enterprise intranet network operable with a protocol selected from the group consisting of H.323 protocol, Session Initiation Protocol (SIP) and Extensible Messaging and Presence Protocol (XMPP).

70. The method for providing telephony presence information to a presence client as recited in claim 65, wherein said telephone line is monitored for detecting voltage levels on a tip-and-ring (T/R) pair of said telephone line.

71. The method for providing telephony presence information to a presence client as recited in claim 65, wherein said telephone line is monitored for detecting voltage levels on a common ground (A1) and control lead (A) pair of said telephone line.

72. The method for providing telephony presence information to a presence client as recited in claim 65, wherein said telephone line is monitored for detecting voice signals over said telephone line.

73. The method for providing telephony presence information to a presence client as recited in claim 65, wherein said telephone line is monitored for detecting Dual Tone Multi-Frequency (DTMF) signals over said telephone line.

74. The method for providing telephony presence information to a presence client as recited in claim 65, wherein said line status information includes a plurality of line states selected from the group consisting of: ring, off-hook, on-hook, serviced, and on-hold.

75. The method for providing telephony presence information to a presence client as recited in claim 65, wherein said line status information includes a plurality of tones selected from the group consisting of a dial tone, ringing tone, dial-stutter tone, a busy tone.

76. The method for providing telephony presence information to a presence client as recited in claim 65, wherein said line status information includes DTMF signaling on said telephone line.

77. The method for providing telephony presence information to a presence client as recited in claim 65, wherein said line status information includes feature capability information relating to said analog telephone.

78. The method for providing telephony presence information to a presence client as recited in claim 65, wherein said line status information is formatted as at least one presence tuple, said at least one presence tuple including one or more telephony presence information elements selected from the group consisting of: idle, busy, call forwarded, do-not-disturb, enabled with call waiting, enabled with caller ID, and other presence information elements based on DTMF signaling and detection and Caller ID detection.

79. The method for providing telephony presence information to a presence client as recited in claim 65, wherein said line status information is collected periodically.

80. The method for providing telephony presence information to a presence client as recited in claim 65, wherein said line status information is collected substantially continuously.

81. The method for providing telephony presence information to a presence client as recited in claim 65, wherein said line status information is collected intermittently.

82. The method for providing telephony presence information to a presence client as recited in claim 65, wherein said line status information is collected upon a change in said line status information.

83. The method for providing telephony presence information to a presence client as recited in claim 65, wherein said line status information is collected upon a request by a presence client disposed in said IP-based network.
